(19) United States
(12) Patent Application Publication
(10) Pub. No.: US 2016/0160741 A1
(43) Pub. Date: Jun. 9, 2016

(54) DUAL FUEL ENGINE WITH MICRO-PILOT FUEL INJECTOR

(71) Applicant: Caterpillar Inc., Peoria, IL (US)

(72) Inventors: Yongxian Gu, West Lafayette, IN (US); Phillip J. Houtz, West Lafayette, IN (US); Keith A. IntVeld, East Lafayette, IN (US)

(73) Assignee: Caterpillar Inc., Peoria, IL (US)

(21) Appl. No.: 15/045,280

(22) Filed: Feb. 17, 2016

(51) Int. Cl. F02B 7/06; F02B 43/10; F02B 19/10

(52) U.S. Cl. CPC F02B 7/06; F02B 19/1004; F02B 19/1023; F02B 19/108; F02B 43/10; F02B 2043/103; F02B 2201/064

(57) ABSTRACT

A dual fuel engine is provided. The dual fuel engine includes an engine cylinder that is adapted to house a piston. A cylinder head is coupled with the engine cylinder. An inlet valve is adapted to inject a second fuel into the engine cylinder. A pre-combustion chamber is adapted to be coupled within the cylinder head to receive a first fuel via a micro-pilot fuel injector. As piston moves towards a top dead center pushing a portion of the second fuel into the pre-combustion chamber via a communication channel, the piston compresses the portion of the second fuel and the first fuel in the pre-combustion chamber for igniting the first fuel and combusting the second fuel. This generates a combustion flame. The pre-combustion chamber is adapted to allow the combustion flame to propagate from the pre-combustion chamber to the engine cylinder via the communication channel.

### TECHNICAL FIELD

The present disclosure relates to dual fuel engines, and more specifically, to a dual fuel engine having a micro-pilot fuel injector.

### BACKGROUND

Diesel engines are widely utilized for a variety of applications. Consequently, due to high power requirements, such machines require a lot of diesel during operation, thereby increasing the operating costs of these machines. In addition to diesel, there are a number of other fuels available such as natural gas and synthesis gas which are lower in cost and have the potential for reducing the operating costs of the machines. However, a standard diesel engine is unable to utilize natural gas as a fuel, as the diesel engine with a single diesel injector cannot have stable natural gas combustion and meet emission targets. A standard diesel engine is therefore, unable to take advantage of low cost fuels such as natural gas.

Currently, multi-fuel engines are in place for multiple applications. The multi-fuel engines utilize multiple types of fuels, such as gasoline blended with natural gas as a fuel. There have been challenges to attain high power requirements while using current multi-fuel engines. Further, gradually increasing the amount of the natural gas in the current multi-fuel engines, for example, from 20% to 60%, leads to unstable combustion and violent fast burning of the fuel mixture. As a result, the current multi-fuel engines are inefficient and impractical for day to day operations.

US Patent Publication Number US20130104850 discloses an internal combustion engine that utilizes multiple fuels. The internal combustion engine includes an ignition chamber installed with a spark plug to ignite a fuel, such as natural gas. The internal combustion engine includes a main nozzle for injecting a second fuel, such as diesel, into a combustion chamber. However, the internal combustion engine disclosed in this reference is a spark ignition engine and not a diesel engine, and therefore is not suitable for heavy machines, or heavy workloads. Therefore, there is a need for a dual fuel engine having a pre-combustion chamber with a micro-pilot fuel injector for ignition of fuels.

### SUMMARY OF THE DISCLOSURE

In one aspect of the present disclosure, a dual fuel engine is provided. The dual fuel engine includes an engine cylinder, a piston, a cylinder head, an inlet valve, a pre-combustion engine, and a micro pilot fuel injector. The engine cylinder is adapted to house the piston. The cylinder head is coupled with the engine cylinder. The inlet valve is adapted to inject a second fuel into the engine cylinder. The pre-combustion chamber is adapted to be coupled within the cylinder head to receive a first fuel. The pre-combustion chamber is in fluid communication with the engine cylinder via one communication channel. The pre-combustion chamber includes a micro-pilot fuel injector to inject the first fuel into the pre-combustion chamber to initiate combustion. The dual fuel engine is adapted to move the piston from a bottom dead center to a top dead center. The piston pushes a portion of the second fuel into the pre-combustion chamber and compresses the portion of the second fuel and the first fuel in the pre-combustion chamber for igniting the first fuel and combusting the second fuel. The pre-combustion chamber is adapted to allow a combustion flame to propagate from the pre-combustion chamber to the engine cylinder via the at least one communication channel, and moving the piston from the top dead center to the bottom dead center.

Other features and aspects of this disclosure will be apparent from the following description and the accompanying drawings.

### BRIEF DESCRIPTION OF THE DRAWINGS

FIG. 1 is a side view of a dual fuel engine without the engine housing, in accordance with the concepts of the present disclosure;

FIG. 2 is a sectional view of a portion of the dual fuel engine having a pre-combustion chamber including a micro-pilot fuel injector and the piston at a bottom dead center, in accordance with the concepts of the present disclosure

FIG. 3 is a sectional view of a portion of the dual fuel engine having the pre-combustion chamber including the micro-pilot fuel injector and the piston at a top dead center, in accordance with the concepts of the present disclosure; and

FIG. 4 is a flowchart of a method for operating the dual fuel engine, in accordance with the concepts of the present disclosure.

### DETAILED DESCRIPTION

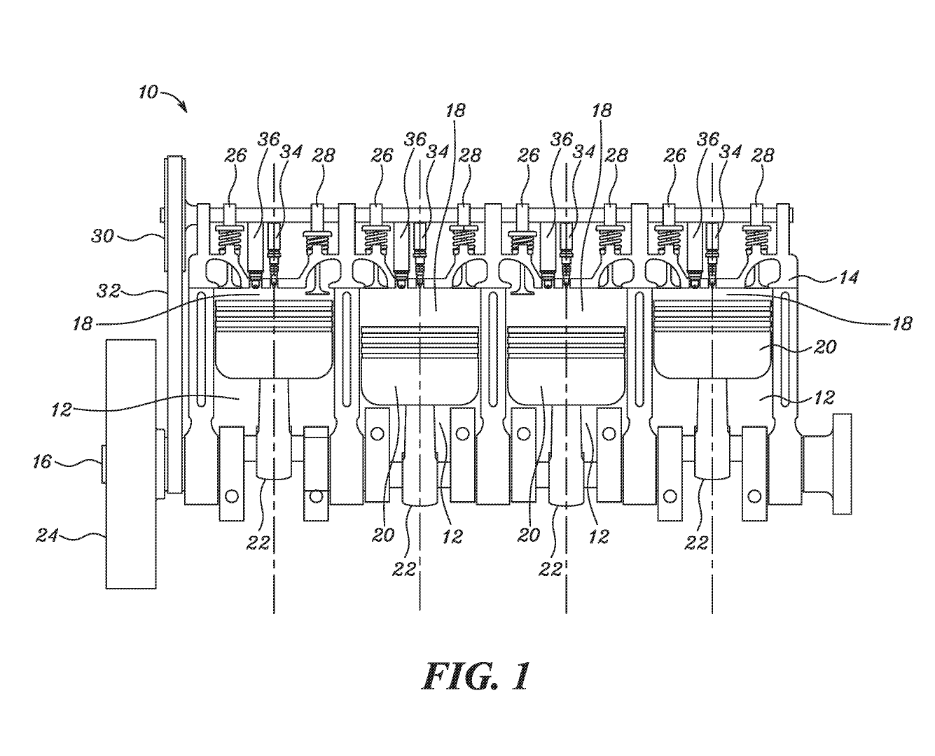

Referring to FIG. 1, a system 10 includes a probe 12 disposed in an exhaust conduit 14. The exhaust conduit 14 is in fluid communication with an engine (not shown), and is adapted to receive exhaust gas from the engine. The probe 12 is adapted to receive a sample of the exhaust gas from the exhaust conduit 14. The probe 12 is in fluid communication with a first sampling module 16. The first sampling module 16 is adapted to provide particulate matter (PM) measurements for the sample of the exhaust gas received from the probe 12. The term particulate matter (PM) measurements for the sample may be interchangeably used with the term gravimetric measurements of the sample, without departing from the scope of the disclosure.

The dual fuel engine 10 is adapted to move the piston 20 in a reciprocating motion. The piston 20 moves up in the engine cylinder 12 to a top dead center (TDC) position and moves down in the engine cylinder 12 to a bottom dead center (BDC) position. It will be apparent to the one skilled in the art that the piston 20 has different shapes, such as rectangular, square without departing from the meaning and scope of the disclosure. The crankshaft 16 converts the reciprocating motion of the piston 20 into a rotational motion. The crankshaft 16 is coupled to a flywheel 24. The flywheel 24 imparts energy to the crankshaft 16 from time to time in order to keep the crankshaft 16 rotating.

The engine cylinder 12 includes an inlet valve 26 and an exhaust valve 28 to allow entry and exit of fuel and air in the combustion chamber 18 of the engine cylinder 12. A camshaft 30 actuates the opening and closing of the inlet valve 26 and the exhaust valve 28. The camshaft 30 is connected to the crankshaft 16 through a belt 32. The belt 32 synchronizes the rotation of the camshaft 30 and the crankshaft 16 in such a way that the inlet valve 26 and the exhaust valve 28 are opened and closed at the time when the entry of fuel in the combustion chamber 18 is required or the rejection of exhaust is required respectively. The dual fuel engine 10 employs various other components, such as filters, pumps, high pressure release valves and pressure regulators (not shown). It would be apparent to the one skilled in the art that the dual fuel engine 10 is a diesel engine or “compression ignition internal combustion engine” or any other kind of engine that performs a variety of operations associated with a particular industry without departing from the meaning and scope of the disclosure. The dual fuel engine 10 is utilized in a variety of machines, such as commercial vehicles, off-highway vehicles, cars, trucks, vans, boats, ships, power generators, stationary gas compressors among others.

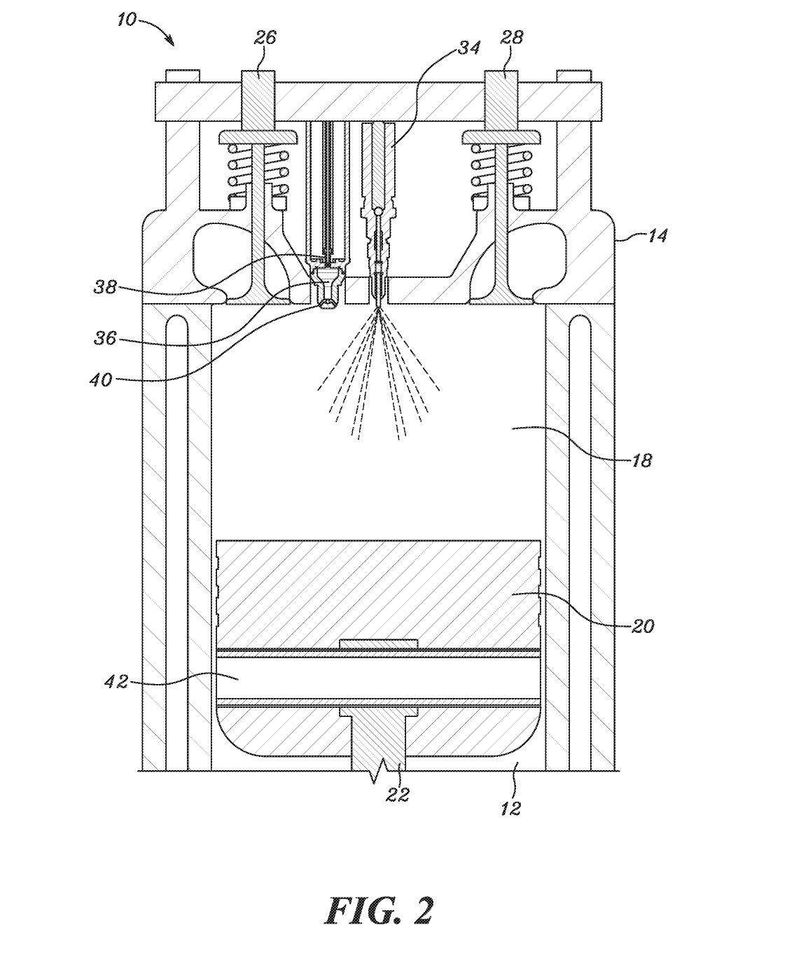

Further, the dual fuel engine 10 includes a fuel injector 34 coupled within the cylinder head 14 of the engine cylinder 12. Also, a pre-combustion chamber 36 is coupled within the cylinder head 14. The pre-combustion chamber 36 includes a micro-pilot fuel injector 38 (shown in FIG. 2) for injecting a small volume (or quantity) of a first fuel to initiate combustion of a gas and air mixture (also called pre-mixed second fuel) in the pre-combustion chamber 36 as described in subsequent paragraphs.

Referring to FIG. 2, the dual fuel engine 10 includes the pre-combustion chamber 36 with the micro-pilot fuel injector 38 and the piston 20 at a bottom dead center. The micro-pilot fuel injector 38 injects the first fuel, such as diesel. In an embodiment, the dual fuel engine 10 is a compression ignition engine that combusts multiple fuels and uses primarily a low auto ignition temperature fuel to burn the fuels and generate combustion.

Further, a second fuel pre-mixed with air is injected through the inlet valve 26 into the combustion chamber 18 of the engine cylinder 12. It would be apparent to the one skilled in the art that the second fuel is a natural gas (also called Liquefied Natural Gas (LNG)), a synthetic gas, a liquefied petroleum gas (i.e. LPG) or any other fuel for performing the operation of the dual fuel engine 10 without departing from the meaning and scope of the disclosure.

The dual fuel engine 10 includes the pre-combustion chamber 36 placed within the cylinder head 14. The pre-combustion chamber 36 includes the micro-pilot fuel injector 38. The pre-combustion chamber 36 is in fluid communication with the combustion chamber 18 via at least one communication channel 40. In an embodiment, the communication channel 40 is a conduit, or an orifice, a mesh or any other channel allowing a passage between the pre-combustion chamber 36 and the combustion chamber 18. Further, the pre-combustion chamber 36 is located at a predetermined distance from the fuel injector 34. The predetermined distance is varied as per the engine design and other requirements without departing from the meaning and scope of the disclosure.

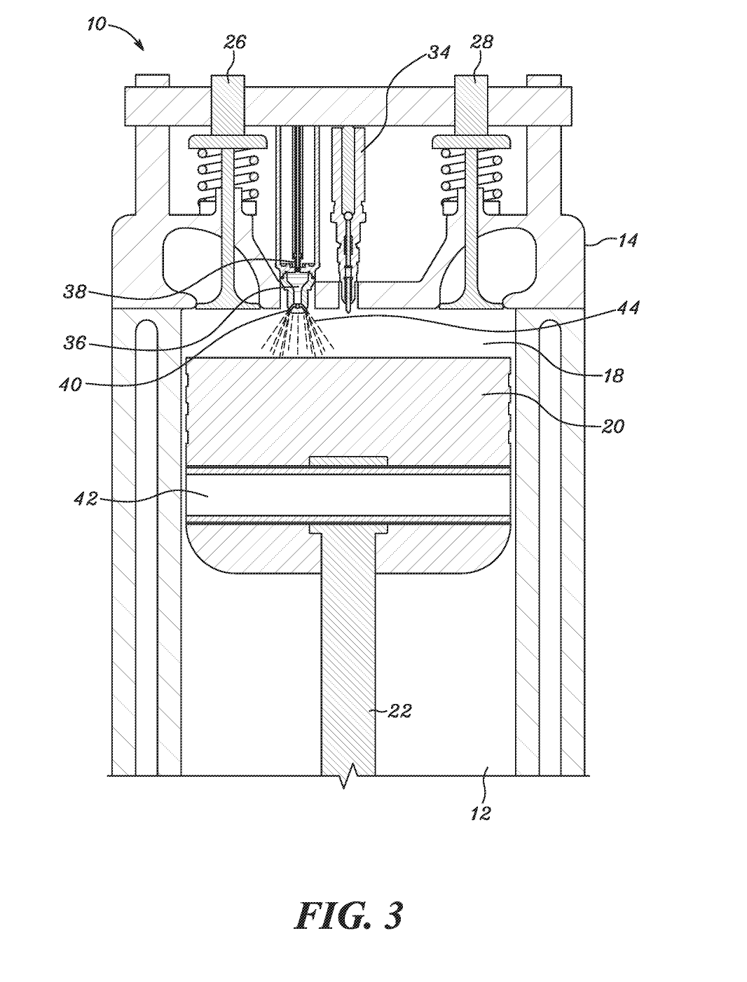

Referring to FIG. 2, the piston 20 is at a bottom dead center of the engine cylinder 12 exposing full capacity of the combustion chamber 18. At this point, the inlet valve 26 opens for the mixture of air and the second fuel to enter the combustion chamber 18. The terms “mixture of the air and the second fuel” may also be interchangeably used as “pre-mixed second fuel” in the detailed description without departing from the meaning and scope of the present disclosure. After allowing a sufficient amount of the pre-mixed second fuel into the combustion chamber 18, the inlet valve 26 closes. Thereafter, the piston 20 is operable to move towards the top dead center from the bottom dead center. As the piston 20 moves towards the top dead center, the piston 20 compresses the pre-mixed second fuel inside the combustion chamber 18. The operation of the dual fuel engine 10 during compression of the pre-mixed second fuel is explained in FIG. 3 below. A gudgeon pin 42 connects the piston 20 and the connecting rod 22. As the piston 20 moves, the gudgeon pin 42 provides a bearing for the connecting rod 22.

Referring to FIG. 3, as explained earlier in FIG. 2, the piston 20 moves towards the bottom dead center to create a suction pressure in order to allow the pre-mixed second fuel into the combustion chamber 18 via the inlet valve 26. The inlet valve 26 closes and the piston 20 moves towards the top dead center of the engine cylinder 12 compressing the pre-mixed second fuel inside the combustion chamber 18. While the piston 20 compresses the pre-mixed second fuel, a small portion of the pre-mixed second fuel enters the pre-combustion chamber 36 via the communication channel 40. Movement of the piston 20 towards the top dead center within the combustion chamber 18 leads to compression of the pre-mixed second fuel in the pre-combustion chamber 36.

Due to compression of the pre-mixed second fuel in the pre-combustion chamber 36, pressure and temperature of the pre-mixed second fuel rises and generates heat inside the pre-combustion chamber 36. At this time, the micro-pilot fuel injector 38 injects a small amount of the first fuel inside the pre-combustion chamber 36. In an embodiment, injected volume of the first fuel from the micro-pilot fuel injector 38 is about 0.3˜1% of total fuel volume. Due to the high temperature and pressure in the pre-combustion chamber 36, the first fuel starts igniting.

The ignition of the first fuel leads to the combustion of the pre-mixed second fuel in the pre-combustion chamber 36, and hence generates a combustion flame 44. The combustion flame 44 propagates to the combustion chamber 18 via the communication channel 40 and the combustion flame 44 also burns the rest of the pre-mixed second fuel present in the combustion chamber 18. Thereafter, due to the combustion of the pre-mixed second fuel inside the combustion chamber 18, the piston 20 moves towards the bottom dead center of the engine cylinder 12. As the piston 20 moves towards the bottom dead center, the piston 20 transfers power via the connecting rod 22 to the crankshaft 16.

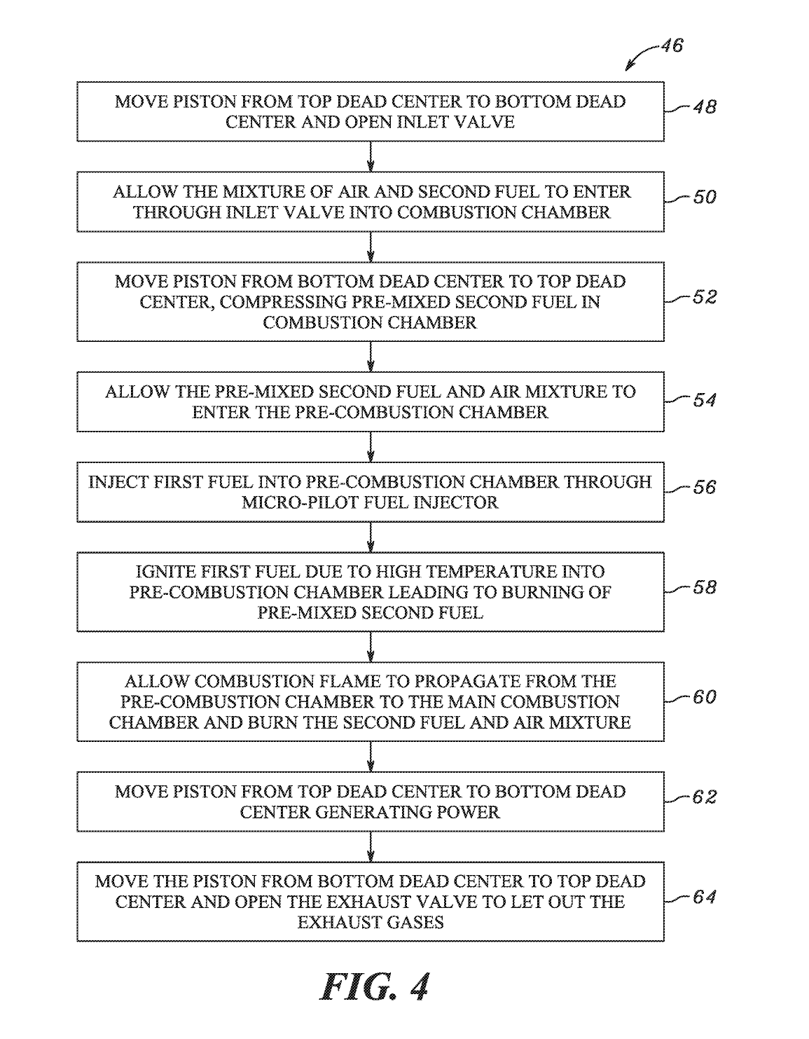

Referring to FIG. 4, a method 46 illustrates the operation of the dual fuel engine 10 in conjunction of FIGS. 1, 2, and 3.

At step 48, the piston 20 moves from the top dead center to the bottom dead center of the engine cylinder 12 and the inlet valve 26 opens.

At step 50, the inlet valve 26 is opened to allow the mixture of the air and the second fuel (also called the pre-mixed second fuel) to enter into the combustion chamber 18. The piston 20 pulls the pre-mixed second fuel into the combustion chamber 18. A pull force is generated by a vacuum created in the combustion chamber 18, when the piston 20 moves from the top dead center to the bottom dead center as shown at the step 48.

At step 52, the piston 20 moves from the bottom dead center to the top dead center to compress the pre-mixed second fuel in the combustion chamber 18. At step 54, a portion of the mixture of the pre-mixed second fuel and air is allowed to enter the pre-combustion chamber 36 via the communication channel 40. Further, due to the movement of the piston 20 in the combustion chamber 18, the portion of the pre-mixed second fuel is also compressed in the pre-combustion chamber 36.

At step 56, the first fuel is injected into the pre-combustion chamber 36 via the micro-pilot fuel injector 38.

At step 58, the heat of the compressed pre-mixed second fuel vaporizes and ignites the first fuel, that in-turn burns the pre-mixed second fuel in the pre-combustion chamber 36. As a result, at step 60, the combustion flame 44 is generated and is propagated to the combustion chamber 18 from the pre-combustion chamber 36 via the communication channel 40 and burns the rest of the pre-mixed second fuel present in the combustion chamber 18.

At step 62, when the combustion is completed, the combusted pre-mixed second fuel expands to move the piston 20 down. The high pressure in the engine cylinder 12 drives the piston 20 downward, supplying power to the crankshaft 16 via the connecting rod 22. At step 64, the exhaust of the combustion moves out via the exhaust valve 28 and the piston 20 moves from the bottom dead center to the top dead center.

### INDUSTRIAL APPLICABILITY

Currently, a diesel engine is unable to exploit natural gas as an alternate fuel and therefore, unable to take advantage of low cost fuels. There have been challenges to attain high power requirements while using current multi-fuel engines.

The present disclosure provides the dual fuel engine 10 that utilizes two fuels, preferably natural gas and diesel. Therefore, the dual fuel engine 10 uses a dual system for both diesel and natural gas operation. The dual fuel engine 10 manages the combustion and emissions at an acceptable range. For the natural gas combustion, the pre-combustion chamber 36 helps to achieve a higher efficiency and to meet emission targets. Further, the micro-pilot fuel ignition in the pre-combustion chamber 36 is very effective to generate robust ignition jets and leads to efficient natural gas combustion. Furthermore, the natural gas substitution rate is approaching 100% instead of much lower rate limited by violent fast burning for the dual fuel mixture. The dual fuel engine 10 helps in saving the fuel cost and delivers more customer value. Further, the dual fuel engine 10 also avoids violent fast burning of the natural gas while the substitution range of natural gas transits from ˜50%-80%.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A dual fuel engine comprising:
an engine cylinder adapted to house a piston;
a cylinder head coupled with the engine cylinder;
an inlet valve adapted to inject a second fuel into the engine cylinder; and
a pre-combustion chamber adapted to be coupled within the cylinder head to receive a first fuel, the pre-combustion chamber being in fluid communication with the engine cylinder via at least one communication channel;
wherein the pre-combustion chamber includes a micro-pilot fuel injector to inject the first fuel into the pre-combustion chamber to initiate combustion;
wherein the dual fuel engine is adapted to move the piston from a bottom dead center to a top dead center, the piston pushes a portion of the second fuel into the pre-combustion chamber and compresses the portion of the second fuel and the first fuel in the pre-combustion chamber for igniting the first fuel and combusting the second fuel;
wherein the pre-combustion chamber is adapted to allow a combustion flame to propagate from the pre-combustion chamber to the engine cylinder via the at least one communication channel, and moving the piston from the top dead center to the bottom dead center.
